(19) United States
(12) Patent Application Publication
(10) Pub. No.: US 2025/0133119 A1
(43) Pub. Date: Apr. 24, 2025

(54) FAULT TOLERANT ZERO TRUST CONTROL PLANE

(71) Applicant: Dell Products L.P., Round Rock, TX (US)

(72) Inventors: Victor da Cruz Ferreira, Rio de Janeiro – RJ (BR); Roberto Nery Stelling Neto, Rio de Janeiro – RJ (BR); Vicente J.P. Amorim, João Monlevade, Minas Gerais (BR); Joubert de Castro Lima, Ouro Preto – MG (BR); Vinicius Facco Rodrigues, São Paulo – SP (BR); Werner Spolidoro Freund, Rio de Janeiro (BR)

(21) Appl. No.: 18/490,703

(22) Filed: Oct. 19, 2023

(51) Int. Cl. H04L 9/40

(52) U.S. Cl. CPC H04L 63/20

(57) ABSTRACT

One example method includes receiving, at a control plane of a zero trust (ZT) architecture, a request to implement a proposed policy, forwarding the request to multiple policy engines of a blockchain policy engine, executing, by the policy engines, a consensus algorithm that decides whether or not the proposed policy will be implemented, wherein, as part of execution of the consensus algorithm, each of the policy engines performs a respective validation process with respect to the proposed policy, and when a consensus is reached by the policy engines, either implementing the proposed policy, or preventing implementation of the proposed policy, as dictated by the consensus.

### FIELD OF THE INVENTION

Embodiments of the present invention generally relate to the handling of access requests for enterprise resources in zero trust (ZT) environments. More particularly, at least some embodiments of the invention relate to systems, hardware, software, computer-readable media, and methods, for access policy management procedures and validation procedures in a ZT environment.

### BACKGROUND

A recent push from governments for a more reliable and secure infrastructure has culminated into a race for Zero Trust (ZT) compliance solutions between several big industry players. The National Institute of Standards and Technology (NIST) looks to consolidate and provide guidelines on what is expected from a Zero Trust Architecture (ZTA) and environment. While the benefits of a ZT environment are clear, various challenges remain.

Telemetry collection, threat intelligence reports, Security Information and Event Management (SIEM) information, activity logs and other inputs to a trust algorithm may eventually lead to the detection of malicious behavior within the system, but some spurious activity may still go under the radar. For example, Advanced Persistent Threats (APT) or attacks that compromise the ZT control plane itself, aiming to subvert the ZTA decision process, may not be noticed until it is too late to react. An additional problem is that it may take some time before the proper corrective actions are taken to protect the control plane in the eventuality of an attack. As a result, it is difficult to securely update and validate policies within the control plane. Further, Secure policy enforcement may be difficult to implement in the presence of failure or attacks. Finally, there is a lack of intrinsic robustness for some ZT elements in the presence of attacks.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a comparative example of a ZT environment.

FIG. 2 discloses aspects of a ZT environment, and associated components including a PDP and PEP, according to an embodiment.

FIG. 3 discloses an environment and procedure for handling new or updated policies, according to one embodiment.

FIG. 4 discloses operations in a method for validating resource access, according to one embodiment.

FIG. 5 discloses a BFT enforcement point user request validation method, according to one embodiment.

FIG. 6 discloses a computing entity operable to perform any of the disclosed methods, processes, operations, and procedures.

### DETAILED DESCRIPTION OF SOME EXAMPLE EMBODIMENTS

Embodiments of the present invention generally relate to the handling of access requests for enterprise resources in zero trust (ZT) environments. More particularly, at least some embodiments of the invention relate to systems, hardware, software, computer-readable media, and methods, for access policy management procedures and validation procedures in a ZT environment.

One example embodiment of the invention is directed to a method that comprises a blockchain-based PDP (policy decision point) policy management procedure, as well as a PEP (policy enforcement point) validation procedure. Elements of this example method may be implemented in a ZT environment that includes a control plane and a data plane.

One or more policy engines (PE) of a PDP in the control plane may employ a blockchain copy of network policies. Within the PDP, a request for changing or updating a policy may be evaluated using a consensus algorithm executed among the PEs to ensure no malicious policies are pushed to the blockchain. External to the PDP, a user access request may be received by a PEP and that request may then trigger another consensus operation in the PDP to validate information relating to that request.

The PEPs in the data plane may be used to enforce policy decisions promulgated by the PDP. Because a PEP may be susceptible to attack, an embodiment may implement a BFT protocol to validate any potentially PEP actions resulting for the user access request. The BFT protocol may determine whether or not the PEP actions will be allowed to be taken.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that malicious access policies may be identified and blocked before can be inadvertently implemented. An embodiment may secure operations and storage policies even in the presence of faults. An embodiment may prevent unauthorized behavior at policy enforcement points. Various other advantages of one or more example embodiments will be apparent from this disclosure.

### A. CONTEXT FOR AN EXAMPLE EMBODIMENT

The following is a discussion of aspects of a context for an embodiment of the invention. This discussion is not intended to limit the scope of the invention, or the applicability of the embodiments, in any way.

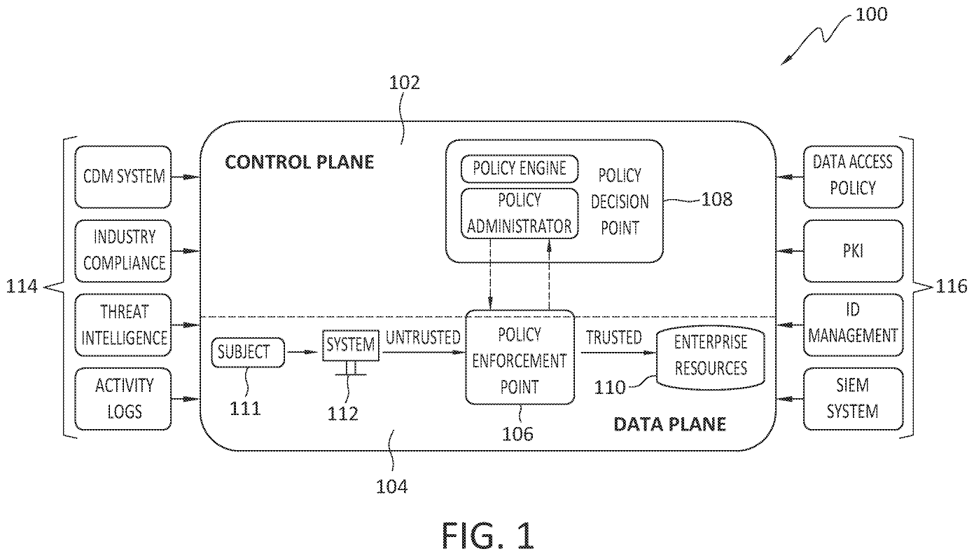

For the purpose of illustrating some aspects of one example embodiment, reference is made to the comparative example of FIG. 1, in which an example ZT environment 100 may comprise a control plane 102, and a data plane 104. The data plane 104 may comprise a policy enforcement point (PEP) 106 and the control plane 102 may comprise a policy decision point (PDP) 108. Any compromise within these components can render the system untrustworthy. From within the PDP point-of-view, securing and validating policies is important for ZT environment 100 effectiveness. In general, the PEP 106 is responsible for terminating and enabling correct resource 110 access for any subject 111, such as an application or user for example, that has/may request, by way of a system 112, such access.

Inputs 114, such as telemetry collection, threat intelligence reports, Security Information and Event Management (SIEM) information, and activity logs, may eventually lead to the detection of malicious behavior within the ZT environment 100, but some spurious activity may still go undetected, even where various controls 116 may have been implemented. For example, APT (advanced persistent threats) or attacks that compromise the control plane 102 itself, aiming to subvert the ZTA decision process, may not be noticed until it is too late to react. An additional problem is that it may take some time before the proper corrective actions are taken to protect the control plane 102 in the eventuality of an attack.

Thus, an example embodiment comprises a modified ZTA, and associated operations, that supports blockchain, smart contracts, and Byzantine Fault Tolerance (BFT) technology as to immediately detect when a PEP is failing, or under attack, as well as guarantee an immutable record for policies inside the PDP in a distributed manner.

### B. OVERVIEW OF SOME ASPECTS OF AN EXAMPLE EMBODIMENT

One example embodiment may comprise various modifications to a ZTA, such as is disclosed in the comparative example of FIG. 1. These modifications may comprise: [1] a PDP trust algorithm to support a blockchain solution with smart contracts to store an immutable record of all policies past and present; and [2] a BFT (byzantine fault tolerance) procedure for request validation when multiple PEPs are in place.

In an embodiment, a BFT protocol executes an algorithm to guarantee honest nodes arrive at the same decision even in the presence of faults or malicious nodes. An embodiment is BFT protocol agnostic and can leverage any algorithm that works in a permissioned environment. Furthermore, distinct respective BFT protocols may be used for the PDP blockchain and PEP validation, given their specific requirements. This approach may be advantageous as each use case may require specific tradeoffs between speed and reliability.

B.1 PDP Policies with Blockchain

An example embodiment may assume various constraints and parameters. For example, a ZT environment may be implemented that comprises a plurality of PEs (policy engines) (PEs) coupled with PAs (policy administrators) inside a PDP. As another example, all PEs may have, or obtain, access to, and will be able to operate over, a blockchain copy of the network policies. Finally, the blockchain policy may serve as an immutable record and enable secure updates for new/changing policies and validation of existing policies.

In an embodiment, the blockchain operations may comprise two different flows. The first flow come from within a PDP and may comprise a request for changing or updating existing policies. Before accepting and committing any changes to the blockchain, a consensus algorithm may be executed between all the PEs within the PDP to ensure that malicious policies are not pushed into the chain. During a consensus algorithm, each PE will vote as to whether or not it will accept or reject the new policy. These individual decisions by the PEs may be based on a smart contract triggered when a request for changing or update arrives.

The second flow in the blockchain operations may come from outside the PDP and may be triggered by a PEP after an access request, such as a user or application request to access system resources such as, but not limited to, memory, storage, a virtual machine (VM), processors such as CPUs and GPUs, communication lines, and network bandwidth. During this stage, it may be the case that only information already present in the blockchain may need to be validated. For example, the PEP validation request may trigger another consensus between the PEs to validate their blockchain information. Like the first flow discussed above, each PE may execute a smart contract that not only validates its blockchain contents but also can receive information from outside sources such as CDM (continuous diagnostics and mitigation) systems or threat intelligence services. The feedback from these outside sources may follow the NIST guidelines (see Rose, Scott, Oliver Borchert, Stu Mitchell, and Sean Connelly. Zero trust architecture. No. NIST Special Publication (SP) 800-207. National Institute of Standards and Technology, 2020—incorporated herein in its entirety by this reference) for a trust algorithm executing in a PE.

B.2 Validating PEPs with BFT

In an embodiment, PEPs enforce policy decisions from the PDP, allowing, or not, user or application access to enterprise resources. If a PEP is attacked or fails, it may hinder the system with delays or allow unauthorized access. Therefore, even though the PDP is secured with the addition of blockchain validation, PEPs responses and control over resources still need to be addressed. In an embodiment, there may be several PEPs in a real world ZT system to avoid single points of failure. An embodiment may leverage this aspect by introducing a BFT protocol into their communication with the objective of validating PEP actions. The objective is that if any PEP behaves unexpectedly, honest PEPs will still arrive at the correct action, in time, via consensus.

### B.3 Further Discussion

As will be apparent from this disclosure, one or more embodiments may possess various useful features and aspects, although no embodiment is required to possess any of such useful features or aspects. Following are some examples.

An embodiment may implement a blockchain-based PDP policy management approach. This approach may employ blockchain and smart contracts for securing operations and storage of policies even in the presence of faults. Moreover, any malicious changes may be blocked immediately and not committed into the chain.

As another example, an embodiment may implement a PEP BFT validation procedure. This procedure may include a validation step using BFT protocols so as to enable a more reliable PEP approval/refusal workflow, while blocking any unauthorized behavior from the enforcement points.

Further, an embodiment may comprise a ZTA architecture with a protocol agnostic solution that can leverage LBFT or any other BFT protocol. In this example ZTA architecture, an embodiment may provide single sign-on a credentials database that is built on top of BFT database replication.

### C. DETAILED DISCUSSION OF ASPECTS OF AN EXAMPLE EMBODIMENT

### C.1 Introduction

The first practical BFT protocol was presented in 1999. The pBFT protocol is composed of five phases. The number of faulty nodes in the system is represented by f. A client starts the protocol by requesting validation or some operation that requires consensus between the nodes of the system. A primary node is responsible for receiving the client request and starting three phases called Pre-prepare, Prepare, and Commit. Note that most pBFT-based protocols still work even when the primary node fails. Moreover, all messages exchanged in all pBFT phases are cryptographically signed. The transactions are considered correct when the client receives f+1 identical results or responses from different nodes in the same view defined by the primary node.

An embodiment may leverage the robustness and flexibility of BFT protocols to enhance the ZTA control plane. An embodiment is BFT protocol agnostic and, as such, any pBFT-based protocol or standard proof-of algorithms may be leveraged depending on the use case trade off requirements.

### C.2 Discussion

One example embodiment comprises a ZT control plane, which may be implemented in whole or in part in hardware, with improved reliability and robustness to attacks and critical component failures. An embodiment may comprise a blockchain environment inside a PDP to support reliable update and validation of existing policies via smart contracts and an enhanced BFT Enforcement Point that increases robustness of PEPs. An embodiment may follow the NIST ZTA design and may be ported into any solution that rests on the same principles and similar components.

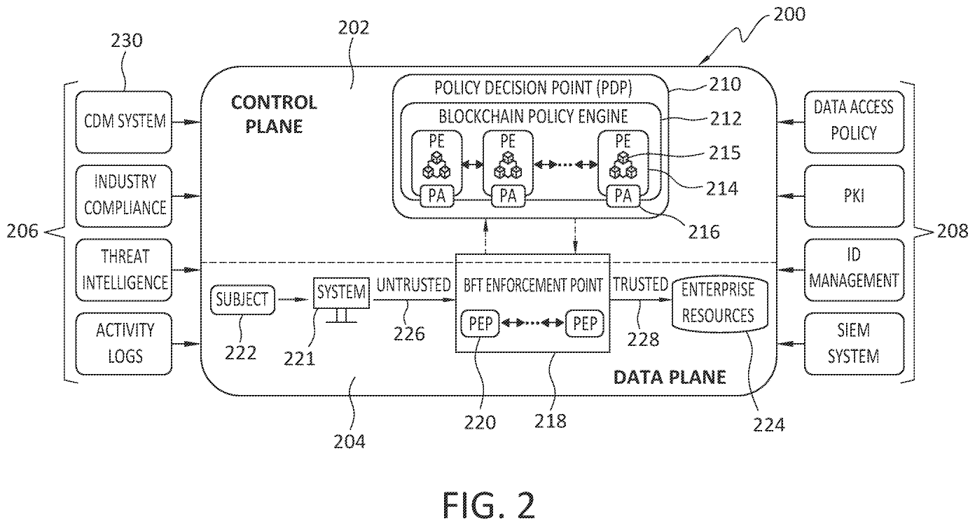

Attention is directed now to FIG. 2 which discloses a ZT architecture, or simply ‘ZTA,’ 200 according to one example embodiment. In an embodiment, the ZTA 200 may comprise an NIST-compliant structure. As shown, the ZTA 200 may comprise a control plane 202 and a data plane 204 that are able to communicate with each other, and with various other entities. Various inputs 206 may be considered in the operations of the ZTA 200, and such inputs 206 may include, but are not limited to, telemetry collection, threat intelligence reports, Security SIEM information, and activity logs. As well, various controls 208 may be implemented, such as to control access to various resources.

FIG. 2 further discloses that the ZTA 200 includes, in the control plane 202, a PDP 210. The PDP 210 may comprise a group 212 of blockchain PEs 214. Each of the blockchain PEs 214 may communicate with other entities, such as entities in the data plane 204, by way of a respective PA (policy administrator) 216. Further, the data plane 204 may comprise a BFT enforcement point 218 that comprises a group of PEPs 220. The BFT enforcement point 218 may communicate with the PDP 210 by way of one or more of the PAs 216. As discussed below, the BFT enforcement point 218 may receive, by way a system 220, access requests from a subject 222 such as an application or user, for access to one or more resources 224.

That is, and with continued reference to the example of FIG. 2, the PDP comprises a blockchain PE 212 comprising multiple PEs 214 and PAs 216. Each PE 214 contains a copy of the blockchain which stores all current and past existing policies. All PEs 214 may communicate with each other to perform usual blockchain operations. The PAs 216 are the interface responsible for communication with PEPs 220. Furthermore, and as noted above, an embodiment may encapsulate multiple PEPs 220 inside a BFT Enforcement Point 218. Once a request 226 is received, every PEP 220 may communicate with each other and collectively perform a BFT protocol to guarantee reliable processing and response even in the presence of the failure of one or more of the PEPs 220. If the request 226 is approved, access 228 is granted to the resources 224. As indicate in FIG. 2, an embodiment may, at least in the interest of scalability, be implemented as a distributed setting with multiple PEPs 220 and PEs 214.

### C.2.1 Blockchain Policy Engine

In an embodiment, the PEs 214 store all policy information within a blockchain 215. The policy blockchain is copied between several PEs 214 that communicate with each other, that is, each of the PEs 214 may have its own copy of the policy blockchain. The blockchain guarantees an immutable record of any policy changes which can be probed or analyzed by a CDM system, such as the CDM system 230.

The blockchains may execute a BFT protocol underneath to guarantee a consensus and reliable blockchain between honest nodes. An example embodiment is protocol agnostic and enables a developer to select any protocol that suits its necessary tradeoffs. During the execution flow of operations within the control plane 202, the PDP 210 can be accessed on two different occasions. The first (1) one is if a new or updated policy is proposed within the ZTA 200, and the second (2) is if there is a resource 224 access request 226 by a user or subject 222. A discussion is provided below as to how the blockchain behaves in these two scenarios.

### C.2.2 Updating and Adding New Policies

In an embodiment, all PEs 214 will have, or have access to, and will be able to operate over, a blockchain copy 215 of the network policies. Other ZTA 200 components may update the policies but, in an embodiment, any changes or operations over the network policies must be reflected on these blockchain copies. In an embodiment, a new or modified policy can only be enacted if it is written in the blockchain 215. Therefore, any updates or new policies need to be first accepted and committed into all PE 214 blockchain copies 215. It is noted that, in an embodiment, the aforementioned flow is performed within the control plane 202.

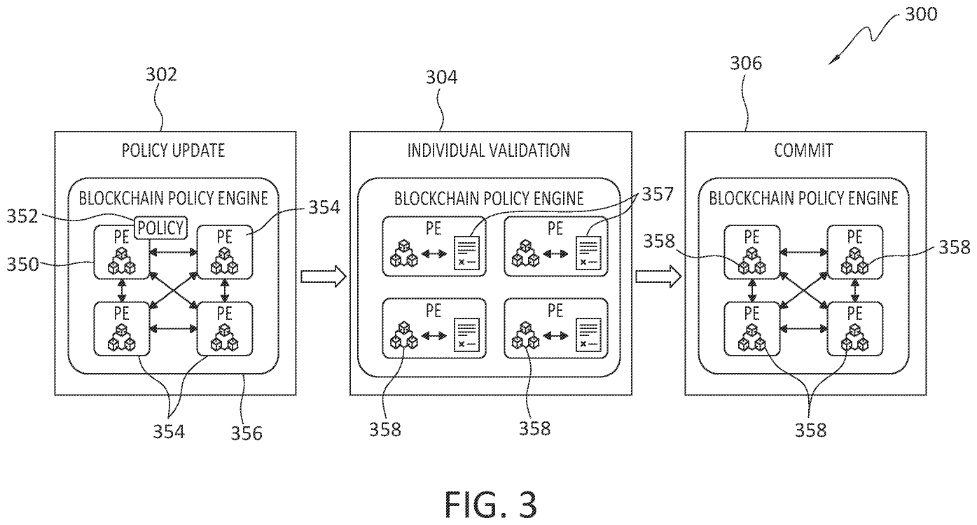

With reference now to the example of FIG. 3, there is disclosed a method 300, which may be performed by a blockchain policy engine running in a control plane, for implementing one or more new, or updated, policies. In the example of FIG. 3, the method 300 comprises various operations to validate new/modified policies into the blockchains of the PEs of the blockchain policy engine. In general, the example method 300 may comprise receipt of request 302 to add a new policy, or to modify an existing policy. The request may then be individually validated by each PE of a blockchain policy engine, and, upon successful validation, the change implicated by the request may be committed 306 to the individual blockchains of the PEs.

The example method 300 may begin when a PE 350, which may be referred to as the ‘initiating PE,’ proposes a new policy 352 or receives an ‘update policy’ request. The initiating PE 350 may forward the proposed new policy or request, as applicable, to all available PEs 354 inside its blockchain PE 356. The PEs 354, along with the initiating PE 350, may then run a consensus algorithm that will vote if the new/modified policy should be committed into the chain, or not. Both the forwarding methodologies and the consensus algorithm may be defined by the BFT protocol.

The individual validation of each PE 350/354 may be based upon the execution of a smart contract 357 at each of the PEs. The smart contract 357 may comprise an immutable program that lives in each of the blockchain 358 copies, and it may be pre-established with guidelines by administrators of what a policy abides to. For example, assuming an RBAC (role-based access control) environment, any policy that gives full access to all available resources to a specific role may serve as a red flag that the smart contract 357 will block and force all PEs 350/354 to vote against the commit, that is, to vote against committing 306 that policy to the blockchains 358.

After the execution of the smart contract 357 by each of the PEs, the consensus algorithm completes and the commit 306 happens in the case of approval, enabling the policy for the entire system. That is, the new/updated policy may be committed 306 to the respective blockchain 358 copies of each of the PEs 350/354.

The benefits of an approach such as that embodied in FIG. 3 may be various. First, the smart contract 357 is immutable and, therefore, the PE 350/354 individual verification algorithms cannot be tampered with. Secondly, in case of a PE 350/354 failure, or any malicious activity, if BFT guarantees are in place, no malicious policy updates will take place nor be committed into the blockchain. Note that a conventional ZT approach may detect such failure and malicious scenarios but their response is delayed, which may provide enough time for resource leaks or system harm to take place. In contrast, an embodiment may immediately block any harm directly, increasing ZT robustness to attacks and failures in the control plane.

### C.2.3 Resource Access Validation

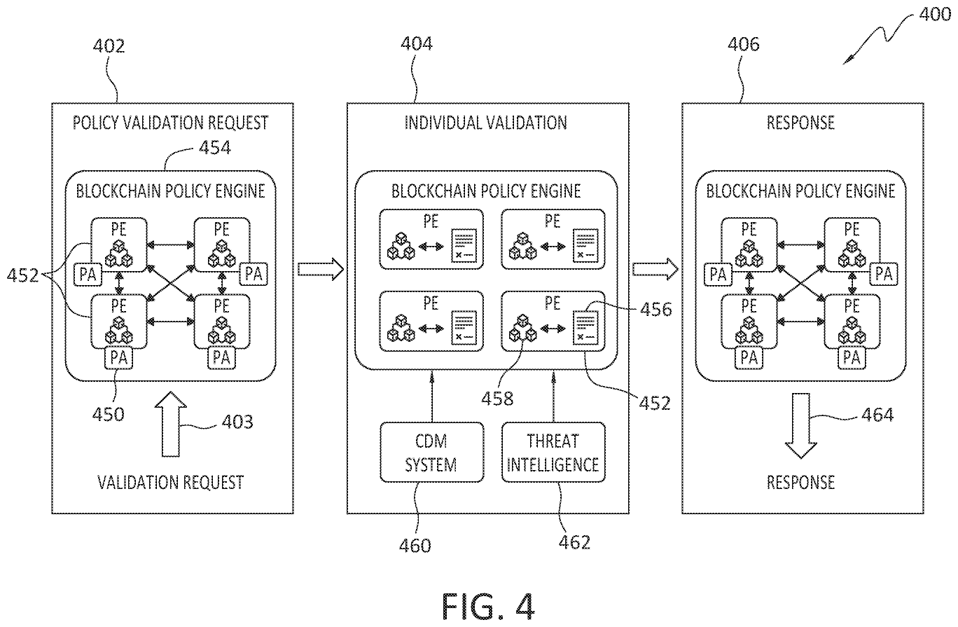

As noted earlier herein, an embodiment may not only update, and add new, policies upon successful validation, but may also validate resource access requests. An example of one approach for validating resource requests is disclosed in FIG. 4.

In an embodiment, all requests from PEPs to PDP (see PEP 220/PDP 210 in FIG. 2), independent of their type, may need to be validated by the PDP. As such, these types of requests may be referred to herein as ‘validation requests.’ In general, the example method 400 of FIG. 4 comprises receipt 402 of a policy validation request, individual validation 404 of that request by a group of PEs of a blockchain policy engine, and a response 406 by the blockchain policy engine to the PEPs of a BFT enforcement point. In general, whenever a user, application or device requests access to a corporate resource, these requests may be validated against policies in force at the time of the request. The validation request reaches the PDP which, in turn, may generate a response, allowing or blocking the operation.

In more detail, the example method 400 starts when any PA 450 receives 402 a ‘validation request’ 403 in FIG. 4, and forwards that request to available PEs 452 inside a blockchain policy engine 454. As in the example of FIG. 3, every PE 452 may execute a smart contract 456 in order to make its decision as to whether or not to grant the requested access. In this case, the smart contract 456 may use information within the blockchain 458 to determine if the policy allows the operation, such as access to a resource, and the smart contract 456 may also receive input from outside resources, as part of a trust algorithm, to guide its final decision. This input may come from a CDM system 460 and/or from threat intelligence services 462 which may block any individual suspicious access that was not committed into the chain as a policy yet, or even deny a request that may be supported by a policy but is marked as suspicious or anomalous by the trust algorithm. After the validation procedure, each PA 450 may send the PE 452 consensus response 462 directly to the available PEPs.

### C.2.4 BFT Enforcement Point

As noted herein, the blockchain approach according to one example embodiment may guarantee the proper operation and storage of policies within the control plane, however, the PEP is the middleware that ultimately allows or terminates connections between a subject and an enterprise resource given the PDP decisions. Therefore, failures or malicious PEPs may create malicious fake user requests, delay user requests to the PDP, or simply ignore PDP resource access termination calls which can lead to system vulnerabilities and exploits.

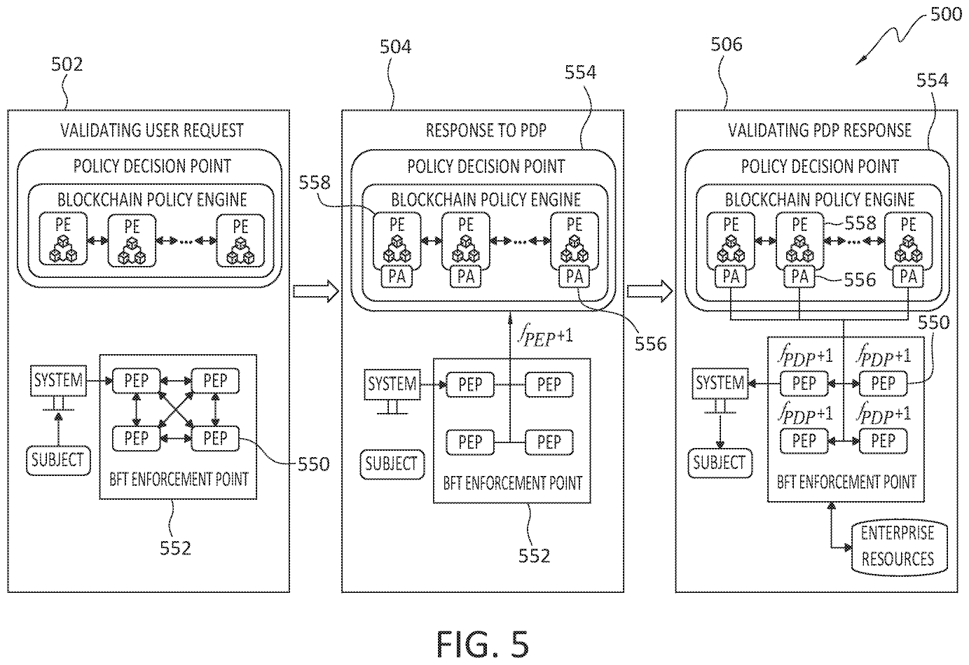

Thus, one embodiment may employ a BFT protocol, between the PEPs in a group of PEPs, that may perform the validations and create a robust PEP environment. Notice that in contrast with the PDP, an embodiment only execute the BFT protocol for request validation, and there may be no blockchain storage of new/modified policies taking place. With reference now to FIG. 5, there is disclosed an example BFT enforcement point user request validation procedure 500 performed, in this non-limiting example, with four PEPs 550, in a data plane. In general, a user request validation procedure 502 may be performed, and the outcome of the procedure 502 may be provided as a response 504 to a PDP. Finally, the PDP may validate 506 the response 504.

In particular, FIG. 5 discloses an example validation procedure for a BFT enforcement point approach such as disclosed herein. Whenever a resource access request arrives at a PEP 550, that request may automatically trigger instantiation of a user request validation by forwarding the access request to all available PEPs 550 inside a BFT enforcement point 552. The PEPs 550 may execute a BFT protocol which confirms that the request is valid and the BFT enforcement point 552 may then provide a response 504 to the PDP 554 indicating that the request has been determined by the PEPs 550 to be valid.

In an embodiment, the PAs 556 may be used as the interface between the PEPs 550 and the PDP 554 to convey the decision of the PEPs 550 to the PEs 558. Following one or more pBFT-based protocols, for example, the PDP 554 may only start its validation after f_{PEP}+1 responses have been received from the PEPs 550, where f_{PEP} is the number of faulty PEPs 550 that the system can accommodate. This operation thus introduces a fault tolerance functionality by preventing a malicious PEP 550 from constantly generating fake requests to overload the PDP 554 policy validation process, and this operation may thus thereby increase robustness in case of a PEP 550 failure. Furthermore, this operation may prevent PEPs 550 from delaying an access request because each PE 558 receives the same request from the various PEPs 550 after a BFT consensus has been reached by the PEPs 550.

After the PEs 558 inside the PDP 554 finish their decision over the user request, the PA 556 associated with the PE 558 will send a response copy to all PEPs 550, as shown at 506. The first PEP 550 to receive f_{PDP}+1 PDP 554 responses will enact the policy, where f_{PDP} are the number of faulty PDPs 554. This secondary step may ensure that a rogue PEP 550 will not perform an action, such as ignoring requested termination of resource access by a bad actor, opposite to the action that was validated by the PDP 554, such as termination of that resource access.

It is noted that, in an embodiment, a rogue PEP 550 cannot grant access to the user where the PDP response was to prevent access, as that PEP 550 will not have the necessary keys and tokens that would be forwarded in a case where the access was allowed. The use of the PEP 550 quorum also avoids delays during the response and the reason is identical to the previous explained access request.

It is noted further that will a conventional ZT approach may detect a failure-prone or malicious PEP 550, there is a time gap between analysis and action in such an approach, thus preventing timely action. In contrast, validating PEP 550 actions when the request is made and when the PDP 554 response is received enables an embodiment to immediately block any unexpected PEP 550 behavior on the spot, without the time delay typically experienced in a conventional ZT approach.

### C.3 Glossary

| Term | Definition |
|---|---|
| ZTA | Zero Trust Architecture |
| PDP | Policy Decision Point, a component of the Zero Trust control plane. |
| | The PDP may comprise two logical components, the Policy Engine |
| | (PE) and the Policy Administrator (PA). |
| PE | Policy Engine, one of the two logical components of the PDP. The PE |
| | is responsible for the ultimate decision to grant access to a resource |
| | for a given subject such as an application or user. The PE may uses |
| | enterprise policy as well as input from external sources, such as CDM |
| | systems, threat intelligence services among other external sources, |
| | as input to a trust algorithm to grant, deny or revoke access to the |
| | resource. The PE may be paired with the policy administrator (PA) |
| | component. The PE may make and log the decision (as approved, or |
| | denied), and the policy administrator executes the decision. |
| PA | Policy Administrator, one of the two logical components of the PDP. |
| | The PA may establish and/or shut down the communication path |
| | between a subject and a resource via commands to relevant PEPs. |
| | It may generate any session-specific authentication and |
| | authentication token or credential used by a client to access an |
| | enterprise resource. It may be tied to the PE and relies on its decision |
| | to ultimately allow or deny a session. If the session is authorized and |
| | the request authenticated, the PA may configure the PEP to allow |
| | the session to start. If the session is denied (or a previous approval |
| | is countermanded), the PA may signal to the PEP to shut down the |
| | connection. Some implementations may treat the PE and PA as a |
| | single service. The PA communicates with the PEP when creating the |
| | communication path. This communication may be implemented via |
| | the control plane. |
| PEP | Policy Enforcement Point. In Zero Trust, a system operable to |
| | perform enabling, monitoring, and eventually terminating, |
| | connections between a subject and an enterprise resource. The PEP |
| | communicates with the PA (part of PDP) to forward requests and/or |
| | receive policy updates from the PA. This may be a single logical |
| | component in ZTA but may be broken into two different |
| | components, namely, the client (e.g., agent on a laptop) and a |
| | resource side (e.g., gateway component in front of resource that |
| | controls access), or a single portal component that acts as a |
| | gatekeeper for communication paths. Beyond the PEP is the trust |
| | zone hosting the enterprise resource. |
| Trust algorithm | The trust algorithm (TA) is the process used by the policy engine (PE) |
| | to ultimately grant or deny access to a resource. The PE may receive |
| | input from multiple sources such as, but not limited to, the policy |
| | database with observable information about subjects, subject |
| | attributes and roles, historical subject behavior patterns, threat |
| | intelligence sources, and other metadata sources. |

### D. EXAMPLE METHODS

It is noted with respect to the disclosed methods, including the example methods of FIGS. 2-5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. FURTHER EXAMPLE EMBODIMENTS

Following are some further example embodiments of the invention. These are presented only by way of example and are not intended to limit the scope of the invention in any way.

Embodiment 1. A method, comprising: receiving, at a control plane of a zero trust (ZT) architecture, a request to implement a proposed policy; forwarding the request to multiple policy engines of a blockchain policy engine; executing, by the policy engines, a consensus algorithm that decides whether or not the proposed policy will be implemented, wherein, as part of execution of the consensus algorithm, each of the policy engines performs a respective validation process with respect to the proposed policy; and when a consensus is reached by the policy engines, either implementing the proposed policy, or preventing implementation of the proposed policy, as dictated by the consensus.

Embodiment 2. The method as recited in any preceding embodiment, wherein each of the validation processes is performed based on execution of an immutable smart contract.

Embodiment 3. The method as recited in any preceding embodiment, wherein when the consensus indicates the proposed policy will be implemented, the proposed policy is committed to a respective policy blockchain that is included in each of the policy engines.

Embodiment 4. The method as recited in any preceding embodiment, wherein the proposed policy is either a new policy, or a modified policy.

Embodiment 5. The method as recited in any preceding embodiment, wherein when the proposed policy is malicious, commitment of the proposed policy to a policy blockchain is prevented immediately after the consensus is reached.

Embodiment 6. The method as recited in any preceding embodiment, wherein each of the policy engines has a respective copy of a policy blockchain that stores one or more policies.

Embodiment 7. The method as recited in any preceding embodiment, wherein the policy engines are elements of a policy decision point that resides in the control plane.

Embodiment 8. The method as recited in any preceding embodiment, wherein each of the policy engines is associated with a respective policy administrator, by way of which that policy engine is able to communicate with a byzantine fault tolerant enforcement point of a data plane.

Embodiment 9. The method as recited in any preceding embodiment, wherein the proposed policy cannot be implemented unless, or until, the proposed policy is committed to a policy blockchain.

Embodiment 10. The method as recited in any preceding embodiment, wherein the proposed policy concerns access to a system resource.

Embodiment 11. A method, comprising: receiving, at a data plane of a zero trust (ZT) architecture, a request to access a system resource; forwarding the request to multiple policy enforcement points; executing, by the policy enforcement points, a consensus algorithm, and providing a resulting consensus to a policy decision point of a control plane; receiving, by each of the policy enforcement points, a response from the policy decision point; and applying, by one of the policy enforcement points, the policy to the request.

Embodiment 12. The method as recited in embodiment 11, wherein the policy enforcement points are implemented in a byzantine fault tolerant enforcement point in the data plane.

Embodiment 13. The method as recited in any of embodiments 11-12, wherein the response from the policy decision points is received at the policy enforcement points by way of policy administrators associated with the policy decision point.

Embodiment 14. The method as recited in any of embodiments 11-13, wherein f_{PEP} is a number of faulty policy enforcement points that can be accommodated while avoiding an overload of a validation process performed by the policy decision point.

Embodiment 15. The method as recited in any of embodiments 11-14, wherein the consensus algorithm comprises a byzantine fault tolerant protocol.

Embodiment 16. The method as recited in any of embodiments 11-15, wherein the policy decision point begins a validation process concerning the request only after f_{PEP}+1 responses are received by the policy decision point from the policy enforcement points.

Embodiment 17. The method as recited in any of embodiments 11-16, wherein when the response from the policy decision point comprises f_{PDP}+1 policy decision point responses, and the policy decision point that applies the policy to the request is a first policy decision point to receive the f_{PDP}+1 responses.

Embodiment 18. The method as recited in embodiments 17, wherein f_{PDP} is a number of faulty policy decisions points.

Embodiment 19. The method as recited in any of embodiments 11-18, wherein the request is received at one of the policy enforcement points.

Embodiment 20. The method as recited in any of embodiments 11-19, wherein the consensus confirms that the request is valid.

Embodiment 21. A system, comprising hardware and/or software, operable to perform any of the operations, methods, or processes, or any portion of any of these, disclosed herein.

Embodiment 22. A non-transitory storage medium having stored therein instructions that are executable by one or more hardware processors to perform operations comprising the operations of any one or more of embodiments 1-20.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

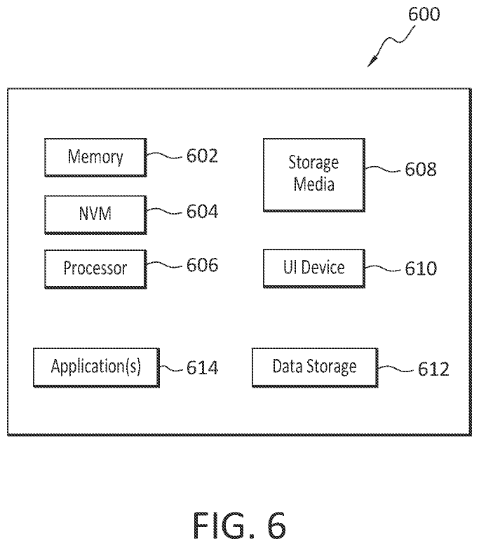

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, at a control plane of a zero trust (ZT) architecture, a request to implement a proposed policy;
forwarding the request to multiple policy engines of a blockchain policy engine;
executing, by the policy engines, a consensus algorithm that decides whether or not the proposed policy will be implemented, wherein, as part of execution of the consensus algorithm, each of the policy engines performs a respective validation process with respect to the proposed policy; and
when a consensus is reached by the policy engines, either implementing the proposed policy, or preventing implementation of the proposed policy, as dictated by the consensus.

2. The method as recited in claim 1, wherein each of the validation processes is performed based on execution of an immutable smart contract.

3. The method as recited in claim 1, wherein when the consensus indicates the proposed policy will be implemented, the proposed policy is committed to a respective policy blockchain that is included in each of the policy engines.

4. The method as recited in claim 1, wherein the validation process is configured to receive additional data from different system components.

5. The method as recited in claim 1, wherein when the proposed policy is malicious, commitment of the proposed policy to a policy blockchain is prevented immediately after the consensus is reached.

6. The method as recited in claim 1, wherein each of the policy engines has a respective copy of a policy blockchain that stores one or more policies.

7. The method as recited in claim 1, wherein the policy engines are elements of a policy decision point that resides in the control plane.

8. The method as recited in claim 1, wherein each of the policy engines is associated with a respective policy administrator, by way of which that policy engine is able to communicate with a byzantine fault tolerant enforcement point of a data plane.

9. The method as recited in claim 1, wherein the proposed policy cannot be implemented unless, or until, the proposed policy is committed to a policy blockchain.

10. The method as recited in claim 1, wherein the proposed policy concerns access to a system resource.

11. A method, comprising:
receiving, at a data plane of a zero trust (ZT) architecture, a request to access a system resource;
forwarding the request to multiple policy enforcement points;
executing, by the policy enforcement points, a consensus algorithm, and providing a resulting consensus to a policy decision point of a control plane;
receiving, by each of the policy enforcement points, a response from the policy decision point; and
applying, by one of the policy enforcement points, the policy to the request.

12. The method as recited in claim 11, wherein the policy enforcement points are implemented in a byzantine fault tolerant enforcement point in the data plane.

13. The method as recited in claim 11, wherein the response from the policy decision points is received at the policy enforcement points by way of policy administrators associated with the policy decision point.

14. The method as recited in claim 11, wherein f_{PEP} is a number of faulty policy enforcement points that can be accommodated while avoiding an overload of a validation process performed by the policy decision point.

15. The method as recited in claim 11, wherein the consensus algorithm comprises a byzantine fault tolerant protocol.

16. The method as recited in claim 11, wherein the policy decision point begins a validation process concerning the request only after f_{PEP}+1 responses are received by the policy decision point from the policy enforcement points.

17. The method as recited in claim 11, wherein when the response from the policy decision point comprises f_{PDP}+1 policy decision point responses, and the policy decision point that applies the policy to the request is a first policy decision point to receive the f_{PDP}+1 responses.

18. The method as recited in claim 17, wherein f_{PDP} is a number of faulty policy decisions points.

19. The method as recited in claim 11, wherein the request is received at one of the policy enforcement points.

20. The method as recited in claim 11, wherein the consensus confirms that the request is valid.
